(19) United States
(12) Patent Application Publication
(10) Pub. No.: US 2009/0195382 A1
(43) Pub. Date: Aug. 6, 2009

(54) VIDEO SENSOR AND ALARM SYSTEM AND METHOD WITH OBJECT AND EVENT CLASSIFICATION

(75) Inventor: Stewart E. Hall, Wellington, FL (US)

Correspondence Address: Christopher & Weisberg, P.A., 200 East Las Olas Boulevard, Suite 2040, Fort Lauderdale, FL, 33301, US

(73) Assignee: Sensormatic Electronics Corporation, Boca Raton, FL (US)

(21) Appl. No.: 12/023,651

(22) Filed: Jan. 31, 2008

(51) Int. Cl. G08B 13/00; G06K 9/46; G06K 9/00; G06K 9/36

(52) U.S. Cl. 340/541; 382/276; 382/195; 382/103; 382/100; 340/3.1

(57) ABSTRACT

A method and system detects an intrusion into a protected area. Image data is captured and processed to create a reduced image dataset having a lower dimensionality than the captured image data. The reduced image dataset is transmitted to a centralized alarm processing device where the reduced image dataset is evaluated to determine an alarm condition.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates generally to a method and system for intrusion detection and more specifically, to a method and system for detecting intrusion through use of an improved alarm system architecture including the ability to classify objects and events in a protected area within a field of vision of a video sensor and to determine alarming conditions based on the behavior of such objects.

### BACKGROUND OF THE INVENTION

Current intrusion detection systems suffer from high false alarm rates due to the use of technology that may incorrectly signal that an intrusion event has occurred, even though no intrusion has actually happened. False alarm signals may generally be caused by the use of technologies that detect measurable changes of various alarm condition parameters in the protected area through some type of sensors without regard to the nature or origination of the event. Examples of such parameters include temperature, e.g., detection of a temperature delta resulting from the presence of a warm body when the surrounding environment is cooler, acoustic vibration signals, e.g., sound waves caused by breaking glass, motion, e.g., detection of changes in reflected microwave signals caused by moving object or body, and integrity of an electrical circuit, e.g., detection of electrical loop being opened or closed by the motion of a door contact magnet away from a magnetic switch. There are many types of sensors and methods for detecting intrusion. Typically intrusion detection systems rely on one or more of these sensor detectors to trigger an alarm signal to the central monitoring center, a cell phone or and/or an audible alarm.

Ideally, an intrusion detection system only alerts in response to an actual “intrusion,” rather than to events that are misinterpreted by the system as an intrusion, e.g., the normal motion of people, animals or objects in the environment, changes in environmental conditions, or environmental noise. Unfortunately, current sensor technologies are all subject to false alarms due to activities or noise in the environment that can trigger an alarm. For example, many current sensor technologies often cannot be used while people are present, because these sensors detect the presence of people in the environment that are not “intruding” into the protected space. With many types of sensors, e.g., temperature or motion detectors, the space cannot be protected unless it is unoccupied. Likewise, the presence and/or motion of animals or other objects in the protected area may cause alarms even when an intrusion did not occur. Other changes in the operating environment or environmental noise can also activate sensors to trigger and alarm. For instance, sudden activation of heating or air conditioning units may cause a rapid fluctuation in temperature in the surrounding area, which may trigger a temperature sensor. Additionally, noise or vibration detectors, which are typically designed to detect the sound of breaking glass, may falsely alert in the presence of other types of noises, e.g., the frequency of the sound of keys jingling is very near to the frequency of breaking glass and has been known to set off intrusion alarm systems.

Traditional methods of avoiding false alarms include disabling sensors that are subject to inadvertent activation during certain periods of time and/or reducing the sensitivity of the actual sensors to decrease the trigger levels. Methods are known that include providing a video device to detect the presence of humans or non-human objects in the protected environment. Many of these methods place the burden of determining whether captured video images represent a human or a non-human at the end device, thereby creating a large demand for processing power at the edge of the system. This implementation creates at least two significant problems.

First, the processors typically used for video human verification are multipurpose digital signal processors (“DSPs”) that extract the salient features from the field of view and then classify the features to detect whether the salient features human or non-human. These processors require a large amount of power to accomplish this task and tend to be quite expensive. The large power drain greatly reduces the battery life of a wireless battery-operated device, adds a significant cost to each of these edge-based devices, and greatly limits the implementation of this approach in many applications. Secondly, when the processor is located at the edge, i.e., in the video sensor or other remote location, all of the processing tasks necessary to extract salient features from the field of view and classify them into objects and events occur in isolation, without the benefit of other similar devices that may be simultaneously monitoring the same objects or events according to their own parameters, e.g., temperature, sound, motion, video, circuit monitoring, etc., and possibly from other perspectives. This isolation limits the ability of the known approaches to provide device integration for collective analysis of the video streams.

Other prior art systems locate the processor used to verify humans within the alarm processing device, i.e. the alarm control panel. This approach places the burden of determining whether images depict a human or non-human object at the alarm panel. One advantage of this approach is that the processing power is centralized, which allows for greater power consumption and integration of multiple devices for collective processing of video streams. However, because the video sensor must transfer tremendous amounts of image data to the alarm panel before the data can be processed, this architecture places a large demand on the system communication interfaces to transmit high bandwidth video from the video sensors to the centralized verification processor (or processors) of the alarm panel. Thus, this architecture places excessive demands for operational power on the edge device, e.g., the video sensor, particularly if the device communicates wirelessly and is battery operated. Additionally, this architecture adds a significant cost to each of the edge devices to provide high bandwidth wireless communications in order to transfer the necessary video data in an adequate amount of time for processing. Further, in these prior art systems, typical processors used for video human verification are general purpose DSPs, which means that an additional processor is required to be designed into many types of alarm panels used in security systems, thereby adding to the cost and complexity of intrusion detection systems.

Additionally, many applications require more than one video sensor to protect all areas covered by the alarm processing device. The communications requirements for transmitting high bandwidth video data from a plurality of video sensors can consume a significant amount of processor resources and power at the central collection point where the human verification processor is located. Thus, this approach may require several processors running in parallel for multiple video sensors. Multiple processors greatly increase the cost, complexity, power consumption, and heat dissipation required for the alarm processing device.

Therefore, what is needed is a system and method for detecting intrusion through use of an improved alarm system architecture that appropriately balances the amount of needed processing capability, power consumption at the sensor devices, and communication bandwidth, while allowing for collective processing in multi-sensor environments to identify objects and alarm, when appropriate.

### SUMMARY OF THE INVENTION

The present invention advantageously provides a method and system for detecting an intrusion into a protected area. One embodiment of the present invention includes at least one video sensor and an alarm processing device. The video sensor captures image data and processes the captured image data, resulting in a reduced image dataset having a lower dimensionality, or overall size, than the captured image data. The video sensor then transmits the reduced image dataset to a centralized alarm processing device, where the reduced image dataset is processed to determine an alarm condition.

In accordance with one aspect, the present invention provides a method for detecting an intrusion into a protected area, in which image data is captured. The captured image data is processed to create a reduced image dataset having a lower dimensionality than the captured image data. The reduced image dataset is transmitted to a centralized alarm processing device. The reduced image dataset is processed at the centralized alarm processing device to determine an alarm condition.

In accordance with another aspect, the present invention provides an intrusion detection system comprising having at least one video sensor and an alarm processing device communicatively coupled to the at least one video sensor. The video sensor operates to capture image data, process the image data to produce a reduced image dataset having a lower dimensionality than the captured image data and transmit the reduced image dataset. The alarm processing device operates to receive the transmitted reduced image dataset, and process the reduced image dataset to determine an alarm condition.

In accordance with still another aspect, the present invention provides a video sensor in which an image capturing device captures image data. A processor is communicatively coupled to the image capturing device. The processor processes the captured image data to produce a reduced image dataset having a lower dimensionality than the captured image data. A communication interface is communicatively coupled to the processor. The communication interface transmits the reduced image dataset.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary intrusion detection system constructed in accordance with the principles of the present invention;

FIG. 2 is a block diagram of an exemplary alarm processing device constructed in accordance with the principles of the present invention;

FIG. 3 is a block diagram of an exemplary video sensor constructed in accordance with the principles of the present invention;

FIG. 4 is a flowchart of an exemplary image data process according to the principles of the present invention; and

FIG. 5 is a flowchart of exemplary extracted feature data processing in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for detecting an intrusion into a protected area. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. Additionally, as used herein and in the appended claims, the term “Zigbee” relates to a suite of high level wireless communication protocols as defined by the Institute of Electrical and Electronics Engineers (IEEE) standard 802.15.4. Further, “Wi-Fi” refers to the communications standard defined by IEEE 802.11. The term “WiMAX” means the communication protocols defined under IEEE 802.16. “Bluetooth” refers to the industrial specification for wireless personal area network (PAN) communication developed by the Bluetooth Special Interest Group. “Ethernet” refers to the communication protocols standardized under IEEE 802.3.

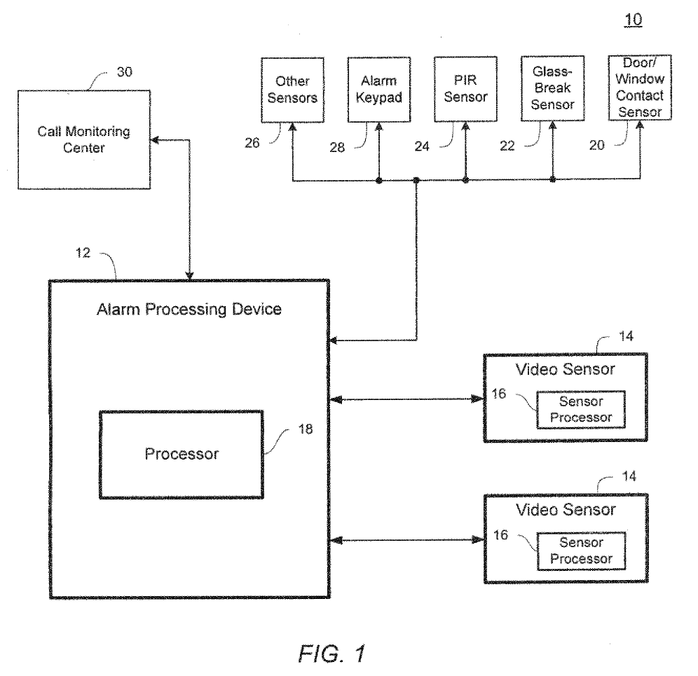

Referring now to the drawing figures in which like reference designators refer to like elements, there is shown in FIG. 1, an intrusion detection system constructed in accordance with the principles of the present invention, and designated generally as “10.” System 10 includes an alarm processing device 12 such as an alarm control panel, in electrical communication with at least one video sensor 14 (two shown) for receiving video data from a protected area under surveillance. Each video sensor 14 includes a sensor processor 16 for pre-processing captured image data to create a reduced image dataset having a lower dimensionality, i.e., overall image size and/or file size, than the captured data prior to transmitting the reduced image dataset to the alarm processing device 12. It should be noted that, although the term “reduced image dataset,” as used herein, could be a recognizable image dataset in the traditional sense, the invention and definition are not so limited. In general, the reduced dataset is not an “image” in the conventional sense, but rather a mathematical representation of the salient features of the image. The alarm processing device 12 also includes a processor 18 for processing the reduced image dataset to determine the existence of an alarm condition.

The alarm processing device 12 may also be in electrical communication with a variety of other sensors, such as electromechanical door/window contact sensors 20, glass-break sensors 22, passive infrared sensors 24, and/or other sensors 26, e.g., heat sensors, noise detectors, microwave frequency motion detectors, etc. Each sensor is designed to detect an intrusion into a protected area. The alarm processing device 12 is also communicatively coupled to an alarm keypad 28, which users may use to perform a variety of functions such as arming and disarming the system 10, setting alarm codes, programming the system 10, and triggering alarms. Additionally, the alarm processing device 12 may optionally be in electrical communication with a call monitoring center 30, which alerts appropriate authorities or designated personnel in the event of an alarm.

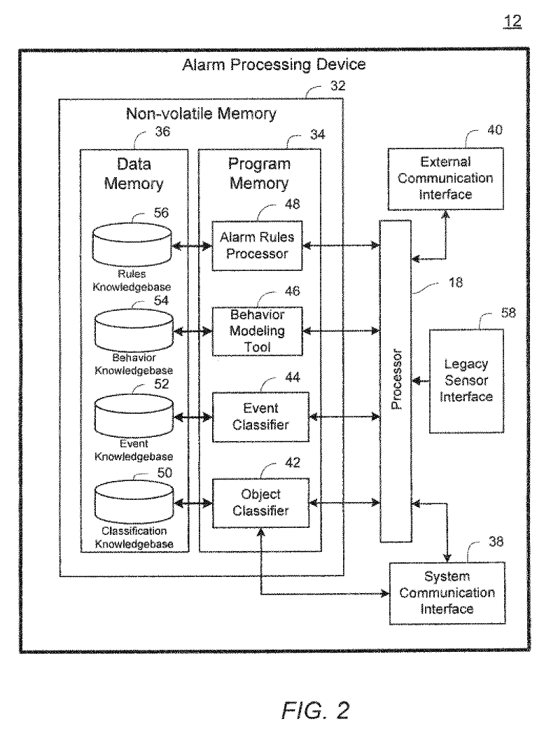

Referring now to FIG. 2, an exemplary alarm processing device 12, according to one embodiment of the present invention, includes a non-volatile memory 32 containing a program memory 34 and a data memory 36. The non-volatile memory 32 is communicatively coupled to the processor 18 which controls the functioning of the alarm processing device 12. The processor 18 may be any device capable of performing the functions described herein such as a microcontroller, microprocessor, digital signal processor (“DSP”), application specific integrated circuit (“ASIC”), or field programmable gate array (“FPGA”), etc.

Additionally, the processor 18 is communicatively coupled to a local system communication interface 38 which receives information from a variety of sensors, e.g., video sensors 14, included within the intrusion detection system 10. The processor 18 may also be communicatively coupled to an external communication interface 40 to facilitate communicate with devices external to the intrusion detection system 10, such as the call monitoring center 30, a gateway (not shown), a router (not shown), etc. Although the system communication interface 38 and the external communication interface 40 are shown as separate devices, it is understood that the functions of each device may be performed by a single device. Each communication interface 38, 40 may be wired or wireless and may operate using any of a number of communication protocols, including but not limited to, Ethernet, Wi-Fi, WiMAX, Bluetooth, and Zigbee.

The program memory 34 contains instruction modules for processing reduced image datasets received from video sensors 14. Preferably, the program memory 34 may contain instruction modules such as an object classifier 42, an event classifier 44, a behavior modeling tool 46 and an alarm rules processor 48. Additionally, the data memory 36 contains databases for use by each instruction module. Exemplary databases include a classification knowledgebase 50, an event knowledgebase 52, a behavior knowledgebase 54 and a rules knowledgebase 56. Each instruction module may be called, as needed, by the processor 18 for processing the reduced image datasets. For example, the object classifier 42 uses the classification knowledgebase 50 to classify salient feature data included in the reduced image dataset to determine the object class of each feature set. The event classifier 44 tracks the objects within the field of view of the video sensor 14 over a period of time to classify the behavior of the object into events which are recorded in the event knowledgebase 52. The behavior modeling tool 46 tracks the various events over time to create models of behaviors of objects and events and stores these models in the behavior knowledgebase 54. The alarm rules processor 48 compares the identified behavior to a set of behavior rules contained in the rules knowledgebase 56 to determine if an alarm condition exists. As more image data is collected, each database 50, 52, 54, 56 may grow in size and complexity, thereby allowing the alarm processing device 12 to acquire knowledge and make more accurate assessments as time progresses.

The alarm processing device 12 may further include a legacy sensor interface 58 for interacting with legacy sensors such as the electromechanical door/window contact sensors 20, glass-break sensors 22, passive infrared sensors 24, and/or other sensors 26.

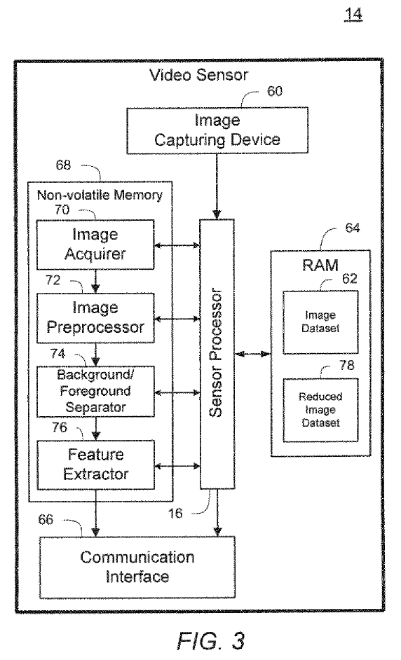

Referring to FIG. 3, an exemplary video sensor 14 of the intrusion detection system 10 of FIG. 1 is shown in more detail, according to one embodiment of the present invention. Each video sensor 14 contains an image capturing device 60, such as a camera, communicatively coupled to the sensor processor 16. Image data 62 captured by the image capturing device 60 is temporarily stored by the sensor processor 16 in random access memory (“RAM”) 64 for processing prior to transmission to the alarm processing device 12 via a communication interface 66.

The sensor processor 16 is further communicatively coupled to non-volatile memory 68. The non-volatile memory 68 stores programmatic instruction modules for processing the data captured by the image capturing device 60. For example, the non-volatile memory 68 may contain an image acquirer 70, an image preprocessor 72, a background/foreground separator 74 and a feature extractor 76. The image acquirer 70 stores data representing an image captured by the image capturing device 60 in an image dataset 62. The image preprocessor 72 pre-processes the captured image data. The background/foreground separator 74 uses information about the current frame of image data and previous frames to determine and separate foreground objects from background objects. The feature extractor 76 extracts the salient features of the foreground objects before transmission to the alarm processing device 12. The resulting reduced image dataset 78 is significantly smaller than the original image dataset 62. By way of example, the size of the captured image dataset 62 can range from low resolution at 320×240 pixels grayscale, e.g., approximately 77 Kbytes per frame, to high resolution at 1280×960 pixels color, e.g., approximately 3.68 Mbytes per frame. When the video sensor processor 16 streams the image, at 10 to 30 frames per second for most application, the data rates are very high; thus benefiting from some sort of compression. The feature extraction techniques of the present invention not only reduce the relevant data in the spatial domain to remove non-salient information, but they also remove the non-salient information in the time domain to allow only salient data to be transmitted; saving power and bandwidth. As an exemplary estimation of bandwidth savings, a large object in a frame may consume only about one fifth of the horizontal frame and half of the vertical frame, i.e. one tenth of the total spatial content. Hence, in the spatial domain, a 77 Kbyte image is reduced to 7.7 Kbytes saving tremendous bandwidth. In the time domain, that object might only appear for a few seconds during an hour of monitoring, which further reduces the transmission time to a very small fraction of the hour and saves power. The simple estimation approach above does not even take into account the ability of feature extraction algorithms to compress image data down even further by measuring characteristics of a particular salient object such as its color, texture, edge features, size, aspect ratio, position, velocity, shape, etc. One or more of these measured characteristics can be used for object classification at the central alarm processing device 12.

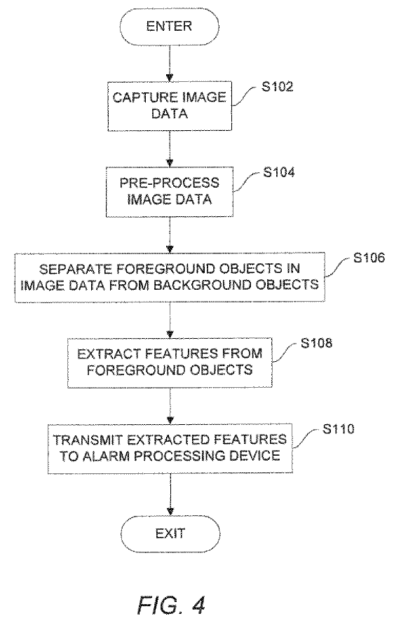

Generally, object and event recognition may be broken down into a series of steps or processes. One embodiment of the present invention strategically locates where each process is performed in the system architecture to most advantageously balance data communication bandwidth, power consumption and cost. Referring to FIG. 4, an exemplary operational flowchart is provided that describes the steps performed by a video sensor 14 for detecting intrusion into a protected area.

The video sensor 14 begins the process by capturing image data (step S102) using an image capturing device 60. The image data is typically an array of values representing color or grey scale intensity values for each pixel of the image. Consequently, the initial image dataset 62 is very large, particularly for detailed images.

The video sensor 14 pre-processes the captured image data (step S104). Pre-processing may involve balancing the data to fit within a given range or removing noise from the image data. The preprocessing step usually involves techniques for modeling and maintaining a background model for the scene. The background model usually is maintained at a pixel and region level to provide the system with a representation of non-salient features, i.e., background features, in the field of view. Each time a new image is acquired, some or all of the background model is updated to allow for gradual or sudden changes in lighting in the image. In addition to the background maintenance and modeling step, the preprocessing may also include other computationally intensive operations on the data such as gradient and edge detection or optical flow measurements that are used in the next step of the process to separate the salient objects in the image from the background. Due to the large amount of data, the pre-processing step is typically computationally intensive; however, the algorithms used in this step are known routines, typically standardized for many applications.

The background/foreground separator 74 uses information about the current and previous frames of image data to determine and separate (step S106) foreground objects from background objects. Algorithms used to separate background objects from foreground objects are also very computationally expensive but are fairly well-established and standardized. However, this process significantly reduces the amount of data in the image dataset 62 by removing irrelevant data, such as background objects, from the desired image.

The feature extractor 76 extracts (step S108) the salient features of the foreground objects. This process again reduces the overall size or dimensionality of the dataset needed to classify objects and determine alarm conditions in subsequent steps. Thus, it is preferable that the extraction step occurs prior to transmitting the reduced image dataset 78 to the alarm processing device 12. However, the extraction step may alternatively be performed after transmission by the processor 18 of the alarm processing device 12. Like the preceding steps, feature extraction also tends to be computationally expensive; however, in accordance with the present invention, feature extraction is performed only on the salient objects in the foreground of the image.

Finally, the video sensor 14 transmits (step S110) the extracted salient features to the alarm processing device 12 via the communication interface 66. These processes performed at the video sensor 14, or other end device, impose a reasonably high computational load requirement on the system. Additionally, the algorithms used for these steps are highly repetitive, i.e. the same processes are performed for each individual pixel or group of pixels in the image or image stream, and are reasonably computationally extensive. Thus, by implementing these processes at the video sensor using parallel processing approaches, e.g. field-programmable gate arrays “FPGAs”, digital signal processors “DSPs”, or application specific integrated circuits “ASICs” with dedicated hardware acceleration, the processing speed is significantly improved and the overall system power requirements are reduced.

Furthermore, because the actual image dataset that is transmitted to the alarm processing device 12 is greatly reduced, the bandwidth required for transmission is consequently reduced, thereby reducing the amount of power needed for data communication. The lower bandwidth requirements are particularly meaningful in relation to wireless, battery-powered units which rely upon extinguishable batteries to supply power. Not only is the overall power-consumption reduced, but the lowered bandwidth requirements allows the use of Low Data Rate Wireless Sensor Network approaches, such as those implemented using Zigbee or Bluetooth communication protocols. These sensors are not only much lower cost than higher bandwidth communication devices, e.g., Wi-Fi devices, but also allow for very low power operation for battery operated devices.

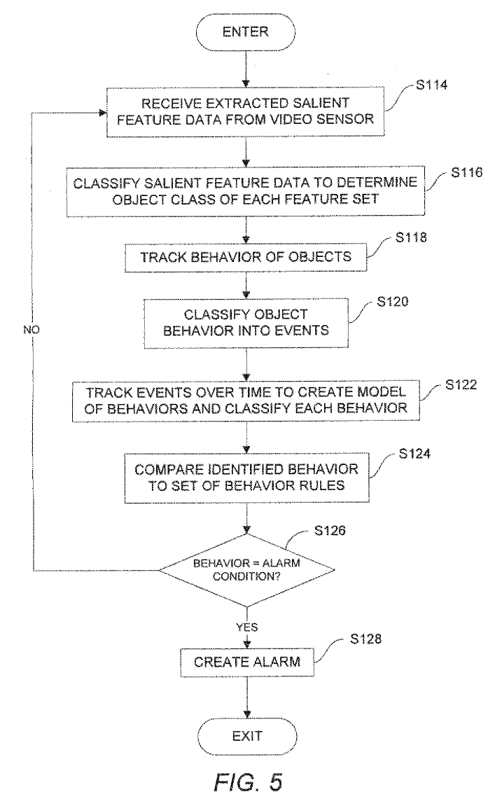

The remaining steps for detecting an alarm condition from an intrusion may be performed by the alarm processing device 12. FIG. 5 depicts an exemplary operational flowchart showing exemplary steps performed by the alarm processing device 12 to detect an intrusion into a protected area. In one embodiment, the alarm processing device 12 receives (step S114) a reduced image dataset 78 containing extracted salient feature data from one or more video sensors 14. The object classifier 42 of the alarm processing device 14 then classifies (step S116) the salient feature data to determine the object class of each feature set. Non-limiting examples of object classes include human and non-human. The object classification process tends to be less computationally expensive than the processes performed at the video sensor 14, e.g., processes described in FIG. 4, because the feature sets contained in the reduced image dataset 78 are significantly reduced in dimensionality as compared to the initial image dataset 62 in that the feature set only includes data relating to foreground objects. Computations for the classification process tend to be quite complex and are often customized for individual applications and/or implementations.

After the feature sets have been classified so that objects can be identified, the event classifier 44 tracks (step S118) the objects within the field of view over a period of time to classify (step S120) the behavior of the object into events. Examples of events may include instances such as: At time t1, Object A appeared at position (x1, y1). At time t2, Object A's position was (x2, y2) and its motion vector was (vx2, vy2). At time t3, Object A disappeared.

The behavior modeling tool 46 tracks (step S122) the various events over time to create models of behaviors of objects and events to describe what the object did. The behavior of each event is classified according to the known behavior models. Continuing the example discussed above, a series of events that may be classified into behaviors may include: “At time t1, Object A appeared at position (x1, y1), moved through position (x2, y2), and disappeared at time t3. Last know position was (x3, y3).” This series of events with the Object A identified as “Human” might be classified to the behavior “Human moved into room from Exterior doorway B and out of room through Interior doorway C.”

Finally, the alarm rules processor 48 compares (step S124) the identified behavior to a set of behavior rules. If, at decision block step S126, the behavior matches the rules defining a known alarm condition, the alarm processing device will initiate an alarm (step S128), e.g., sound audible alert, send alarm message to call monitoring center, etc. Returning to decision block step S126, if the behavior does not match a known alarm condition, no alarm is initiated and the alarm processing device 12 returns to the beginning of the routine to receive a new reduced image dataset (step S114).

The functions performed by the alarm processing device 12, e.g., processes described in FIG. 5, are generally non-standard and customized for individual applications. Although there may be some limited opportunities for parallel processing, generally, the reduced dataset allows for serial processing methods having a great deal of programmatic complexity to provide for handling customized modeling and classification algorithms. Since these steps place a much lower computational load on the processor 18 in alarm processing device 12, the same processor 18 may be used for traditional alarm panel functionality including monitoring legacy sensors such as door and window contacts, passive infrared detectors, microwave motion detectors, glass break sensors, etc.

Additionally, because the alarm processing device 12 can be centralized, data collected from multiple devices, e.g., video sensors, electromagnetic door and window sensors, motion detectors, audible detectors, etc., may be used to model object and event classification and behavior. For example, the presence or absence of an alarm signal from a door or window contact may be used to assist in determining the level of threat provided by an object within the field of view. Image data collected from multiple video sensors may be used to construct databases of object classes, event classes and behavior models. By processing images received substantially concurrently from multiple video sensors, the intrusion detection system is able to more accurately determine an actual intrusion. For example, data obtained from multiple video sensors viewing the same protected area from different angles may be combined to form a composite image dataset that provides for a clearer determination of the actual events occurring. Additionally, the data obtained from multiple video sensors may be combined into a larger database, but not necessarily into a composite image, and processed substantially concurrently to determine whether an alarm condition exists based on alarm rule conditions defined by behaviors observed in multiple views.

The exemplary system architecture of the present invention exhibits numerous advantages over the prior art. The architecture places the burden of repetitive processes using high bandwidth data near the image capturing source, thereby allowing the end devices to implement low bandwidth communications. Lower bandwidth communications means that the end devices cost less and can operate using battery power. Additional power savings may be gained at the end device from the use of ASICs or FPGAs to provide highly parallel processing and hardware acceleration.

By using flexible processing architectures, such as microcontrollers, microprocessors, or DSPs at the alarm processing device, the present invention allows for the design of highly customized object and event classification, behavior modeling, and alarm rule processing algorithms. This flexibility allows the program or system firmware to be easily updated or modified to accommodate requirements for specific applications.

Another advantage of the present invention over the prior art is that video data collected at the video sensor is inherently obfuscated before transmission, providing a greater degree of privacy without fear that data may be intercepted during a wireless transmission.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for detecting an intrusion into a protected area, the method comprising:
capturing image data;
processing the captured image data to create a reduced image dataset having a lower dimensionality than the captured image data;
transmitting the reduced image dataset to a centralized alarm processing device; and
processing the reduced image dataset at the centralized alarm processing device to determine an alarm condition.

2. The method of claim 1, wherein processing the captured image data comprises:
separating foreground objects in the image data from background objects; and
removing the background objects from the image data.

3. The method of claim 2, wherein processing the captured image data further comprises extracting salient features from the foreground objects.

4. The method of claim 1, wherein processing the reduced image dataset comprises:
classifying salient features contained in the reduced image dataset to identify a corresponding object;
tracking a motion of each identified object in the reduced image dataset;
recording a series of events associated with the motion of each identified object;
classifying each associated series of events as at least one behavior associated with the identified object;
comparing each behavior to a set of predetermined behavior rules; and
determining the existence of an alarm condition based on the comparison of the at least one behavior to the predetermined behavior rules.

5. The method of claim 4, wherein processing the reduced image dataset comprises:
extracting the salient features from a foreground object included in the reduced image dataset prior to classifying all salient features.

6. The method of claim 1, wherein processing the reduced image dataset comprises:
receiving at the centralized alarm processing device, a plurality of reduced image datasets;
combining the plurality of reduced image datasets into a combined image dataset; and
processing the combined image dataset.

7. The method of claim 6, wherein the combined image dataset includes a composite image of the protected area.

8. An intrusion detection system comprising:
at least one video sensor, the video sensor:
capturing image data,
processing the image data to produce a reduced image dataset having a lower dimensionality than the captured image data, and
transmitting the reduced image dataset; and
an alarm processing device communicatively coupled to the at least one video sensor, the alarm processing device:
receiving the transmitted reduced image dataset, and
processing the reduced image dataset to determine an alarm condition.

9. The intrusion detection system of claim 8, wherein the at least one video sensor includes:
an image capturing device, the image capturing device capturing image data;
a sensor processor communicatively coupled to the image capturing device, the processor:
separating foreground objects in the image data from background objects;
removing the background objects from the image data; and
extracting salient features from the foreground objects to produce the reduced image dataset; and
a communications interface communicatively coupled to the processor, the communications interface transmitting the reduced image dataset to the alarm processing device.

10. The intrusion detection system of claim 9, wherein the sensor processor is at least one of a digital signal processor, an application specific integrated circuit, and a field programmable gate array.

11. The intrusion detection system of claim 9, wherein the communications interface communicates using at least one of Zigbee, Bluetooth, and Wi-Fi communication protocols.

12. The intrusion detection system of claim 8, wherein the alarm processing device includes:
a communication interface, the communication interface receiving the reduced image dataset from the at least one video sensor; and
a processor communicatively coupled to the communication interface, the processor:
classifying salient features contained in the reduced image dataset to identify a corresponding object;
tracking a motion of each identified object in the reduced image dataset;
recording a series of events associated with the motion of each identified object;
classifying each associated series of events as at least one behavior associated with the identified object;
comparing each behavior to a set of predetermined behavior rules; and
determining the existence of an alarm condition based on the comparison of the at least one behavior to the predetermined behavior rules.

13. The intrusion detection system of claim 12, wherein the processor is one of a digital signal processor, an application specific integrated circuit, and a field programmable gate array.

14. The intrusion detection system of claim 12, wherein the behavior rules are derived by tracking events over time to create models of behaviors of objects and events.

15. The intrusion detection system of claim 12, wherein the communication interface communicates using at least one of Zigbee, Bluetooth, and Wi-Fi communication protocols.

16. The intrusion detection system of claim 12, wherein there are a plurality of video sensors, wherein the communication interface further receives a reduced image datasets from each of the plurality of video sensors; and
wherein the processor further:
combines the plurality of reduced image datasets into a combined image dataset, and
processes the combined image dataset.

17. A video sensor comprising:
an image capturing device, the image capturing device capturing image data;
a processor communicatively coupled to the image capturing device, the processor processing the captured image data to produce a reduced image dataset having a lower dimensionality than the captured image data; and
a communication interface communicatively coupled to the processor, the communication interface transmitting the reduced image dataset.

18. The video sensor of claim 17, wherein processing the image data comprises:
separating foreground objects in the image data from background objects;
removing the background objects from the image data; and
extracting salient features from the foreground objects to produce the reduced image dataset.

19. The video sensor of claim 17, wherein the processor is one of a digital signal processor, an application specific integrated circuit, and a field programmable gate array.

20. The video sensor of claim 17, wherein the communications interface communicates using at least one of Zigbee, Bluetooth, and Wi-Fi communication protocols.
